(19) United States
(12) Patent Application Publication
(10) Pub. No.: US 2011/0311829 A1
(43) Pub. Date: Dec. 22, 2011

(54) CO2 EMISSION-FREE CONSTRUCTION MATERIAL MADE OF CO2

(76) Inventor: Kolja Kuse, Munchen (DE)

(21) Appl. No.: 13/143,193

(22) PCT Filed: Nov. 27, 2009
(86) PCT No.: PCT/EP2009/008497

§ 371 Date: Jul. 3, 2011

(30) Foreign Application Priority Data
Nov. 27, 2008 (DE) 202008015775.7

(51) Int. Cl. B32B 5/02; C09D 1/00; B32B 9/00; C09D 177/00

(52) U.S. Cl. 428/446; 524/606; 523/400; 106/286.8; 428/474.4; 428/688

(57) ABSTRACT

The invention describes a method for CO₂—emissions neutral, in a second step associated with a CO₂ emissions negative balance, production of pressure- and tension-stable building materials.

By the process of energy production by burning of fossil or renewable burning materials, rapid growth of algae is being stimulated by sequestration of CO₂, in order to utilize algae oil for the production of synthetic fibers, which are serving in particular for the production of carbon fibers to be further processed in such a way, that they are able to replace—in combination with natural stone for example—such CO₂—intensive building materials like concrete, steel, glass and aluminum.

The needed high temperatures for the production of carbon fibers will be generated in a CO₂-neutral manner by help of bundling of sun rays with the help of for example parabolic mirror technology.

This approach provides the fundamental basis for the formation of an initially CO2—neutral, later in time CO₂-negative balance based further industrial development, in order to get control on and reverse global warming on Earth step by step over time.

The present invention relates to a production practice of CO₂-emissions neutral, or CO₂-emissions -free respectively, building materials. In a second step CO₂ shall be even removed from the atmosphere by the process of energy production being necessary for the production of the building material and permanently be bound in the building materials.

The process is being described based on a new, previously unknown material flow. In front of the background of nowadays not disclaimed happening global warming, it is important to optimize in particular those processes which require a lot of production energy. A significant energy sink is the production of materials having high pressure and tensile strength at the same time such as concrete, steel reinforced concrete, steel, glass and aluminum.

Without these materials, industrial manufacturing of necessary facilities and consumer goods of a modern living standard, such as buildings, vehicles and machinery are currently not imaginable.

The production of these materials, which are artificially created by man, needs indeed large amounts of energy, which currently can only be obtained by a sufficient extent of fossil burning.

Thereby large amounts of CO₂ are being released, accelerating the long term climate change by heating up the atmosphere in such a way that the climate system is threatening to generate intolerable living conditions on planet Earth or even turn around completely, in case the CO₂—emissions will not be slowed down and be permanently brought down to almost zero, respectively—at a certain level of concentration of CO₂ in the atmosphere—a reduction of CO₂ from the atmosphere is becoming necessary in order to come close to the climate target for example to go not beyond a warming limit of 2° C. by year 2100 and then, ideally, get back step by step down to preindustrial levels again.

The present invention therefore proposes a procedure to produce pressure and tension stable materials in a CO₂—neutral way, and if necessary to remove CO₂ continuously over long periods from the atmosphere again through their own production.

Recently, we succeeded to separate CO₂ from flue gas in fossil-fueled power plants.

This CO₂ is being discharged for example into vessels with salt water, in which algae growth is being stimulated through photosynthesis.

The algae absorb the carbon very quickly, faster than plants growing in air, releasing precious oxygen. From the algae it is easily possible to win oil.

The essence of the invention is based on the idea to use that oil as raw material, in order to produce synthetic fibers.

These synthetic fibers may be of such nature that they are further processed inter alia into coal fibers or carbon fibers or aramid fibers.

The necessary energy for the CO₂—sequestration, the production of the fibers and the needed pressure-resistant material components, such as natural stone and the other needed energies for the production of the algae oil are being derived from conventional power plants burning fossil fuels and/or renewable fuels such as biodiesel and other renewable energy sources like solar, wind and hydroelectric power stations, with a surplus of that energy contributing to other generally needed power supply.

The carbon, which did previously cause the CO₂—problem, is now tied into the building material of carbon fiber or aramid fiber.

The CO₂—neutrally produced, tension stable carbon fibers and aramid fibers are able—in cooperation with pressure-resistant materials such as natural stone—to replace the currently used tension and pressure resistant conventional building materials such as concrete, steel and aluminum.

By combining the fiber of high tensile strength with compression resistant materials that nature provides in the form of natural stone, available in unlimited quantities without a lot of energy expenditure, the required amount of carbon fiber or aramid fiber is significantly reduced.

The resulting building material is henceforward based only on the primary materials of salt water, carbon and natural stone, the energy source for the production of the building materials in the medium term is based on fossil burning and the sun, and in the long-term renewable burning—such as biodiesel—and the sun (with the help of parabolic power plants, for example), since in this way, in the very long-term and through the generated energy savings by replacement of steel, Aluminum and concrete by fiber reinforced natural stone, a state can be reached, where it will be possible in the long run to abandon primary energy from fossil burning.

By the combustion of regenerative burning materials, CO₂ will be fed to the growth of algae, which has been previously in the atmosphere and which now becomes—on the basis of the algae oil—carbon fiber, and thus is being derived into an essential part of building materials.

This process chain finally leads to reduction of CO₂ from the atmosphere, which is being sustainably removed from atmosphere, since the building material is a solid state body, that will not decompose in form of the carbon fiber, but remains permanently stable even after disposal due to its coal constituents.

In the end—stage of the process, the atmosphere will be withdrawn from CO₂ by the energy generation using biodiesel power plants and carbon—sequestration by just as much as necessary.

At the end of this possibly decades or even centuries-long lasting process, the energy sources driving this process chain can be replaced by clean renewable energy sources of solar energy using parabolic mirror technology.

Also the pyrolysis process necessary fort he carbon fiber production can be supplied with the related necessary high temperatures to above 1400° C. by bundling of solar energy with help of parabolic mirror technology. In this way an industry can be built, that is based on CO₂-neutral or even CO₂—negative balances, without any need to abandon the necessary building and construction materials. The building material or a part of it respectively originates from the carbon itself, acting harmful in the atmosphere, and will be bound permanently within the building material, which will be discarded permanently bound underground after use or is being recycled accordingly.

One of the many possible implementations of the invention describes a material-chain or a substance chain circuit respectively with an arrangement of a conventional fossil burning (for example coal powered plant) fired power plant (1), whose exhaust gas separator (2) sequestrates the CO₂ (3) and intakes it into a salt water tank (4), in which algae (6) grow with the help of sunlight (5), which are being collected. From the algae (6) vegetable oil (8) is being obtained in oil-presses (7), which is being processed at first in production plants (9) to become synthetic fibers and then with help of sunray-bundling driven pyrolysis being processed into carbon fibers (10). Woven fiber mats (11) are being produced from the carbon fibers.

The energy for the pyrolysis process for the carbonation of the fibers is being provided by the sunlight (5) with the help of parabolic mirror technology. These carbon fibers or carbon fiber mats (11) are being combined with low energy winnable pressure-resistant materials such as natural stone (12) to become hybrid building and construction materials.

The natural stone will be coated by the fibers with the help of epoxy resin, which is also being won from the algae oil, thus forming a CO₂—neutrally won building material, from which, for example, more power plants (1), buildings and vehicles can be built. The energy being needed for the cutting of the stone and the production processes of the fibers and resin will be provided by the power plant (1).

The conventional power plant (1) will be gradually replaced by power plants that are fired with renewable plant-based fuels instead of fossil burnings, in order to win the CO₂ which is being bound within the renewably growing fuels from the atmosphere, by capturing the CO₂ being bound in the renewable plant-fuels, in order to use it for the production of carbon fibers with help oft he algae growth. Hence valuable high performance tension stable building material is being derived from CO₂ previously bound within the atmosphere, whereas the carbon is permanently bound within the building material.

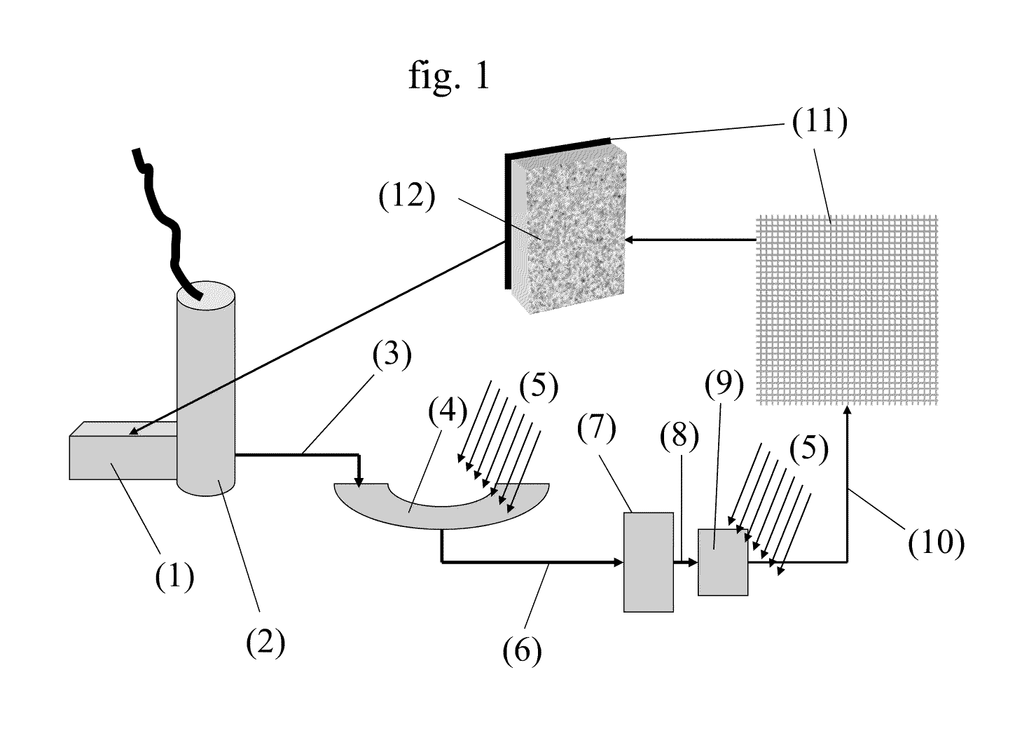

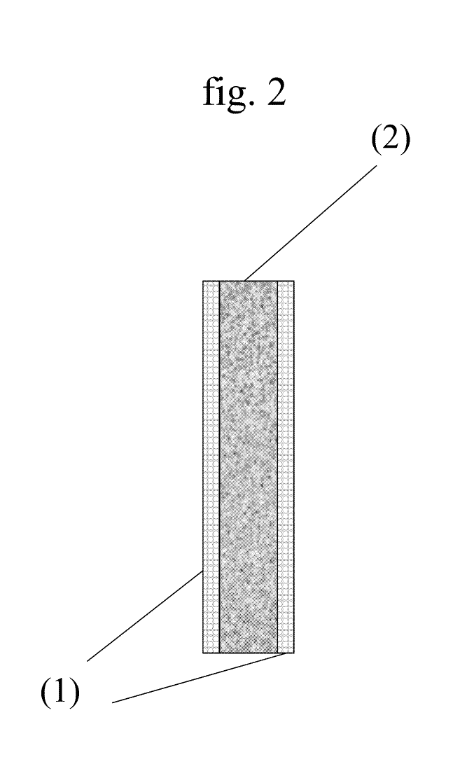

FIG. 2 shows the cross section of a natural stone plate (2) being stabilized with synthetic fibers (1), being produced on the basis of algae oil, for the construction of buildings, vehicles, ships and other industrial and consumer goods using stabilization methods of natural stone by fibrous material, also known as “stone composite technology” or CFS “carbon fiber stone” respectively, when the stone is being coated under preload of the carbon fibers.

1. The main claim relates to a building material made of synthetic fibers or a combination of synthetic fibers with a pressure-resistant material, characterized in that the synthetic fibers includes a base material being gathered from algae oil, and that tension and/or pressure resistant building-and construction-materials are being produced from these synthetic fibers.

2. Configuration according to claim 1, characterized in that the fibers are being processed into carbon fibers or aramid fibers

3. Configuration according to claim 1, characterized in that the carbon fibers are being combined with pressure-resistant material to form hybrid materials.

4. Configuration according to claim 1, characterized in that the pressure-resistant materials preferably includes natural stone or cast stone or concrete or other pressure-stable materials that can be won with a low energy input.

5. Configuration according to claim 1, characterized in that the pressure-resistant materials are being coated, stabilized and eventually being brought under preload by help oft the fibers and resin.

6. Configuration according to claim 1, characterized in that at the end of the processing chain, a CO₂-emissions poor or a CO₂-emissions-free building material is being generated, which is mechanically equivalent or superior to CO₂-emissions intensive and traditional building materials such as steel, aluminum and concrete.

7. Configuration according to claim 1, characterized in that the needed high pyrolysis temperatures for the production of carbon fiber are being generated by bundling of sun rays.
